(19) United States
(12) Patent Application Publication
(10) Pub. No.: US 2019/0257059 A1
(43) Pub. Date: Aug. 22, 2019

(54) WATER FOUNTAIN APPARATUS

(71) Applicant: Drink Right LLC, Canton, OH (US)

(72) Inventor: Nicholas Ralph Scassa, Canton, OH (US)

(21) Appl. No.: 16/279,183

(22) Filed: Feb. 19, 2019

Related U.S. Application Data
(60) Provisional application No. 62/632,156, filed on Feb. 19, 2018.

(51) Int. Cl. E03B 9/20; E03C 1/086

(52) U.S. Cl. CPC E03B 9/20; B05B 1/326; E03C 1/086

(57) ABSTRACT

A water fountain apparatus including a body including a wall, a top end, a bottom end is disclosed. The wall has an interior surface defining a bore and the bore extends from an opening in the top end to an opening in the bottom end. The bore includes a first portion proximate the top end and a second portion proximate the bottom end. The second portion of the bore is of a greater diameter than the first portion of the bore. The water fountain apparatus may further include a filter mechanism provided within the bore, an engaging mechanism operably engaged with the bottom end of the body, a cover operably engaged with the body, and a valve mechanism that is located in the bore.

### CROSS REFERENCE TO RELATED APPLICATIONS

This application claims the benefit of U.S. Provisional Patent Application Ser. No. 62/632,156, filed on Feb. 19, 2018; the disclosure of which is incorporated herein by reference.

### BACKGROUND

### Technical Field

The present disclosure relates to personal sanitary devices. More particularly, the present disclosure relates to a personal sanitary device for a water fountain. Specifically, the present disclosure relates to a personal sanitary device for a water fountain including a body that is releasably engageable with the water fountain.

### Background Information

Generally, a water fountain, which may also be referred to as a drinking fountain or bubbler, is a fountain designed to provide drinking water. The water fountain typically includes a basin, a water supply, and a bubbler head to provide a controlled water stream from the water supply and over the basin.

Typically, a user manipulates a valve on the bubbler head to create the water flow. The valve may be operated by depressing a button provided on a side wall of the water fountain. When a user opens the valve, a controlled water stream is typically projected upwardly in an arcuate manner above the basin so that user is able to drink from the stream. Once the user is done drinking from the stream, the user closes the valve, by releasing the button, to stop the water supply. The closing of the valve prevents the controlled water stream from flowing. Any water not consumed by the user is collected in the basin and is emptied therefrom via a drain. Water fountains are typically provided in public places such as schools, hospitals, parks, libraries, rest areas, grocery stores, places of employment and the like. Since water fountains are open and available to the public, it is likely that many different users will utilize any particular water fountain and might come into contact with the bubbler head and other components of that water fountain. Such contact may cause undesired contamination of the bubbler head and the other various components of the water fountain. Sources of contamination may include, but are not limited to, a user touching the bubbler head with their hand or mouth or the splashing of water from the user's mouth back towards the bubbler head. If the user is ill with a cold, for example, touching the bubbler head or control button with an unwashed hand can transfer bacteria from the user onto the bubbler head or control button. If the user coughs while bending to drink from the fountain, they may spread airborne bacteria and/or saliva-borne bacteria onto walls of the water fountain. Subsequent users of the water fountain may come into contact with these contaminated walls, may be infected with the previously deposited bacteria, and become ill.

Another drawback associated with water fountains is that, in some instances, the water they provide may include impurities from the water supply or from the pipes leading to the water fountain. These impurities may include substances that are not beneficial to people who drink from any particular water fountain.

### SUMMARY

The present inventor has recognized that it is desirable to provide a more sanitary way for people to obtain water from water fountains. The water fountain apparatus disclosed herein provides one suitable way for a user to obtain water from a water fountain. The present inventor has further recognized that it may be beneficial to remove undesirable chemicals, biological contaminants, suspended solids, gases, and the like from water delivered by a water fountain before consumption. The water fountain apparatus disclosed herein also aids in removing undesirable chemicals, biological contaminants, suspended solids, gases, and the like from water delivered by water fountains.

In one aspect, the present disclosure may provide a water fountain apparatus comprising a body including a wall, a top end, a bottom end, wherein the wall has an interior surface; and a bore defined by the interior surface; wherein the bore extends from an opening in the top end to an opening in the bottom end; wherein the bore includes a first portion proximate the top end and a second portion proximate the bottom end; and wherein the second portion of the bore is of a greater diameter than the first portion of the bore. The water fountain apparatus may further include a filter mechanism provided within the bore. In one example, the filter mechanism is provided within the second portion of the bore. The water fountain apparatus may further include an engaging mechanism operably engaged with the bottom end of the body. In one example, the engaging mechanism is a magnet. The water fountain apparatus may further include a cover operably engaged with the body, wherein the cover is adapted to cover a portion of a water fountain.

The water fountain apparatus may further include an insert, wherein the insert includes an exterior wall, a first end, a second end, an interior surface, and a through hole; wherein the through hole extends from an opening in the first end of the insert to an opening in the second end of the insert; and wherein the insert is located within the bore. The water fountain apparatus may further include a valve mechanism that is located in the bore; and wherein the valve mechanism is movable between an open position and a closed position.

The interior surface of the wall of the body further defines an interior cavity and part of the interior cavity is interposed between the first portion of the bore and the second portion of the bore; and wherein the interior cavity is of a greater diameter than the first portion of the bore and the second portion of the bore.

In one aspect, the present disclosure may provide a water fountain apparatus comprising a body having a top surface and a bottom surface; an aperture defined by body and extending between the top surface and the bottom surface; and a conduit having a passageway; said conduit extending outwardly from one of the top surface and the bottom surface of the body, said conduit being positioned such that the passageway is in fluid communication with the aperture. The passageway may be substantially perpendicular to the bottom surface of the body. The body may be made of a bendable material.

In one aspect, the present disclosure may provide a method, the method comprising providing a body including a wall having a top end, a bottom end and an interior surface that bounds and defines a bore; wherein the bore extends from an opening in the top end to an opening in the bottom end; positioning the bottom end of the body over a discharge port of a water fountain; establishing fluid communication between the bore and the discharge port; and conveying water from the discharge port through the bore and out of the opening in the top end. The method further includes preventing germs on the water fountain from contacting a user. The method further includes filtering the water via the filtering mechanism provided in the bore. The method further includes operably engaging the bottom end of the body with the discharge port via a connection mechanism. The method further includes magnetically engaging the bottom end of the body with the discharge port. In one example, conveying water from the discharge port through the bore may be accomplished by depressing a button on the water fountain. In another example, conveying water from the discharge port through the bore is accomplished by activating a motion sensor. The method further includes providing a storage/dispensing container proximate the water fountain; storing the body within the storage/dispensing container; and retrieving the body from the storage/dispensing container prior to positioning the bottom end of the body over the discharge port of the water fountain.

In one aspect, the present disclosure may provide a water fountain apparatus including a body including a wall, a top end, a bottom end. The wall has an interior surface defining a bore and the bore extends from an opening in the top end to an opening in the bottom end. The bore includes a first portion proximate the top end and a second portion proximate the bottom end. The second portion of the bore is of a greater diameter than the first portion of the bore. The water fountain apparatus may further include a filter mechanism provided within the bore, an engaging mechanism operably engaged with the bottom end of the body, a cover operably engaged with the body, and a valve mechanism that is located in the bore.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front perspective view of one embodiment of a water fountain apparatus;

FIG. 2 is a cross-section view taken along line 2-2 of FIG. 1;

FIG. 3 is a diagrammatical environmental view of the water fountain apparatus of FIG. 1 releasably engaged with a discharge port of a water fountain;

FIG. 4A is a cross-section view similar to the cross-section view of FIG. 2 of a second embodiment of the water fountain apparatus releasably engaged with the discharge port of the water fountain;

FIG. 4B is a cross-section view similar to the cross-section view of FIG. 2 of a third embodiment of the water fountain apparatus;

FIG. 4C is a cross-section view similar to the cross-section view of FIG. 2 of a fourth embodiment of the water fountain apparatus;

FIG. 4D is a cross-section view similar to the cross-section view of FIG. 2 of a fifth embodiment of the water fountain apparatus;

FIG. 4E is a diagrammatical environmental view of a sixth embodiment of the water fountain apparatus releasably engaged with the discharge port of the water fountain;

FIG. 5 is a front elevational view of one embodiment of a storage/dispensing container releasably storing one embodiment of the water fountain apparatus;

FIG. 6 is a front elevational view of one embodiment of a storage/dispensing container releasably storing one embodiment of the water fountain apparatus;

FIG. 7 is a front perspective view of a seventh embodiment of a water fountain apparatus;

FIG. 8 is a cross-section view taken along line 8A-8A of FIG. 7;

FIG. 9 is a diagrammatical environmental view of the seventh embodiment of the water fountain apparatus releasably engaged with the discharge port of the water fountain;

FIG. 10 is a perspective view of one embodiment of a water fountain apparatus;

FIG. 11 is an elevation view taken along line 11-11 of FIG. 10;

FIG. 12 is a diagrammatical environmental view of the water fountain apparatus of FIG. 10 releasably engaged with the discharge port of the water fountain;

FIG. 13 is a diagrammatical environmental view of the water fountain apparatus of FIG. 10 and the water fountain apparatus of FIG. 4A releasably engaged with the discharge port of the water fountain; and

FIG. 14 is a flow chart of one method or process in accordance with the present disclosure.

Similar numbers refer to similar parts throughout the drawings.

### DETAILED DESCRIPTION

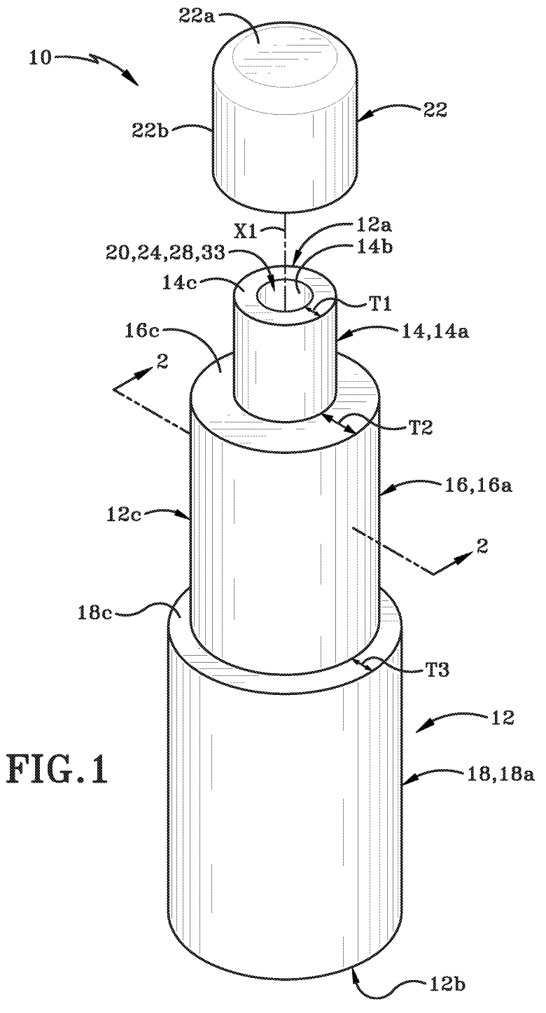

Referring to FIGS. 1-3, there is shown one embodiment of a water fountain apparatus in accordance with one aspect of the present disclosure, with the water fountain apparatus generally indicated at 10.

With reference to FIG. 1, and in accordance with one embodiment of the present disclosure, the water fountain apparatus 10 includes a generally elongated body 12 including a top end 12a, a bottom end 12b, an exterior wall 12c, and an interior surface 12d. The top end 12a and bottom end 12b define a longitudinal direction therebetween. The body 12 further includes a central longitudinal axis X1 extending through the center of the body 12 from the top end 12a through to the bottom end 12b as shown in FIG. 1.

With continued reference to FIG. 1, the body 12 includes a first section 14, a second section 16, and a third section 18. The first section 14 is positioned longitudinally between the top end 12a of the body 12 and the second section 16. The second section 16 is positioned longitudinally between the first section 14 and the third section 18. The third section 18 is positioned longitudinally between the second section 16 and the bottom end 12b of the body 12. The first section 14, the second section 16, and the third section 18 are coaxial but of different diameters as further described below.

As shown in FIG. 1, the first section 14, the second section 16, and the third section 18 are each cylindrical in shape and circular in cross section; however, the first section 14, the second section 16, and the third section 18 may be any suitable shape and have any suitable cross section. The first section 14 is smaller than the second section 16 and the second section 16 is smaller than the third section 18; however, the first section 14, the second section 16, and the third section 18 may be any suitable sizes. It is further envisioned that the first section 14, the second section 16, and the third section 18 may be operably engaged in a telescoping configuration; however, the first section 14, the second section 16, and the third section 18 may be operably engaged in any suitable manner.

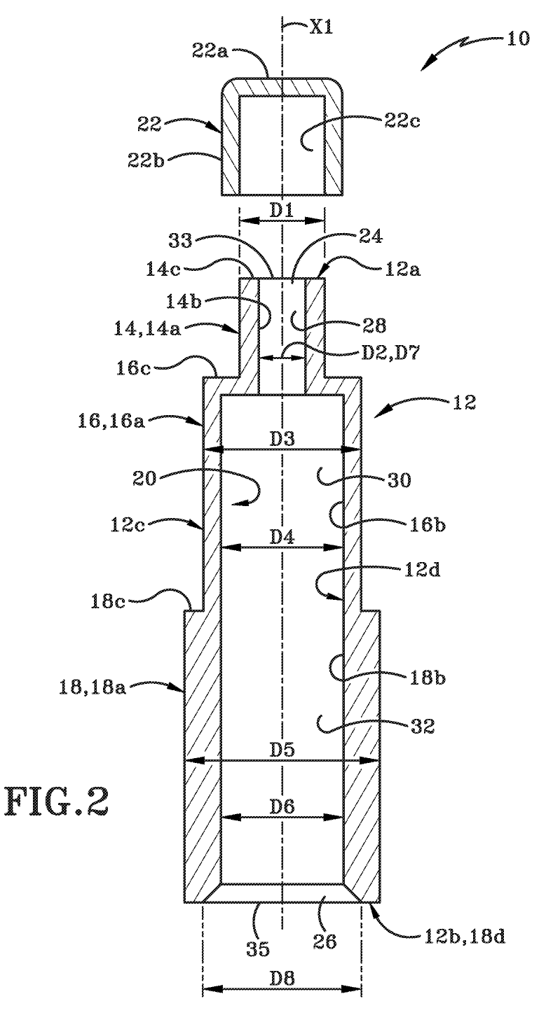

With continued reference to FIG. 1 and FIG. 2, the first section 14 includes an outer generally cylindrical wall 14a having a first diameter D1 and an inner generally cylindrical surface 14b having a second diameter D2. The first section 14 includes a top generally annular wall 14c having a first thickness T1 (FIG. 1).

With continued reference to FIG. 1 and FIG. 2, the second section 16 includes an outer generally cylindrical wall 16a having a third diameter D3 and an inner generally cylindrical surface 16b having a fourth diameter D4. The second section 16 includes a top generally annular wall 16c having a second thickness T2 (FIG. 1).

With continued reference to FIG. 1 and FIG. 2, the third section 18 includes an outer generally cylindrical wall 18a having a fifth diameter D5 and an inner generally cylindrical surface 18b having a sixth diameter D6. The third section 18 includes a top generally annular wall 18c having a third thickness T3 (FIG. 1) and a bottom generally annular wall 18d (FIG. 2).

With continued reference to FIG. 1 and FIG. 2, the first diameter D1 is smaller than the third diameter D3, the third diameter D3 is smaller than the fifth diameter D5, the second diameter D2 is smaller than the fourth diameter D4, and the fourth diameter D4 is equal to the sixth diameter D6. Although the sizes of the first diameter D1, the second diameter D2, the third diameter D3, the fourth diameter D4, the fifth diameter D5, and the sixth diameter D6 have been compared to one another, it is to be entirely understood that the first diameter D1, the second diameter D2, the third diameter D3, the fourth diameter D4, the fifth diameter D5, and the sixth diameter D6 may be any suitable diameters having any suitable lengths.

With continued reference to FIG. 1, the first thickness T1 is smaller than the second thickness T2 and the first thickness is equal to the third thickness T3. Although the sizes of the first thickness T1, the second thickness T2, and the third thickness T3 have been compared to one another, it is to be entirely understood that the first thickness T1, the second thickness T2, and the third thickness T3 may be any suitable thicknesses.

The interior surface 12d of the body 12 defines a bore 20 extending longitudinally generally along the central longitudinal axis X1. The bore 20 includes a first end 24 proximate top end 12a of body 12 and a second end 26 proximate bottom end 12b of body 12. An opening 33 to first end 24 of bore 20 is defined in top end 12a and an opening 35 to second end 26 of bore 20 is defined in bottom end 12b.

The bore 20 further includes a first portion proximate top end 12a and a second portion proximate bottom end 12b. The first portion of bore 20 comprises a first bore section 28 that is defined by inner surface 14b of first section 14. The second portion of bore 20 comprises a second bore section 30 defined by inner surface 16b of second section 16 as well as a third bore section 32 defined by inner surface 18b of third section 18. The first bore section 28 is positioned longitudinally between the top end 12a of the body 12 and the second bore section 30. The second bore section 30 is positioned longitudinally between the first bore section 28 and the third bore section 32. The third bore section 32 is positioned longitudinally between the second bore section 30 and the bottom end 12b of the body 12.

The diameter of the first portion of bore 20, i.e., the diameter of first bore section 28, is the second diameter D2. The diameter of the second portion of bore 20, i.e., the diameter of second bore section 30 and third bore section 32 is greater than the diameter of the first portion of bore 20. In particular, the diameter of second bore section 30 is the fourth diameter D4 and the diameter of third bore section 32 is the sixth diameter D6 and, as is evident from FIG. 2, the fourth diameter D4 and sixth diameter D6 are substantially identical.

The body 12 further includes an opening 33 defined by the top generally annular wall 14c of the first section 14 proximate the first end 24 of the bore 20. The opening 33 is in fluid communication with the bore 20. With reference to FIG. 2, the opening 33 has a seventh diameter D7 which, in this embodiment, is the same size as the second diameter D2. The body 12 further includes a tapered opening 35 defined by the bottom generally annular wall 18d of the third section 18 proximate the second end 26 of the bore 20. The opening 35 is in fluid communication with the bore 20. With reference to FIG. 2, the opening 35 has an eighth diameter D8 which tapers longitudinally towards the top end 12a of the body 12. As shown in FIG. 2, the seventh diameter D7 is smaller than the eighth diameter D8; however, the seventh diameter D7 and the eighth diameter D8 may be any diameters having any suitable length. Further, although the eighth diameter D8 has been described as tapering longitudinally towards the top end 12a of the body 12, the eighth diameter D8 may be configured in any suitable manner.

As shown in FIG. 1 through FIG. 2, the first section 14, the second section 16, and the third section 18 are integrally molded as a single monolithic component. Although the first section 14, the second section 16, and the third section 18 have been described as being integrally molded as a single monolithic component, it is to be entirely understood that that the first section 14, the second section 16, and the third section 18 may be formed in any suitable manner.

The body 12 further includes a cap 22 that is releasably engageable with at least a portion of the first section 14 and is configured to cover an end of the bore 20 proximate the top end 12a of the body 12 as further described below.

With continued reference to FIG. 1 and FIG. 2, the cap 22 is configured to be releasably engaged with at least a portion of the first section 14 via an interference fit engagement to cover the opening 33. As shown in FIG. 1 and FIG. 2, the cap 22 includes a top wall 22a a side wall 22b that bound and define a cavity 22c that is sized to receive the first section 14 therein. The cap 22 is connected to the first section 14 via an interference fit connection and is movable between an open position and a closed position. As such, the cap 22 is slightly larger than the first section 14. The cap 22 is configured to protect the first section 14 and areas around the opening 33 from contamination before use of the water fountain apparatus 10. Although the engagement of the cap 22 to the first section 14 has been described as being an interference fit engagement, it is envisioned that any suitable engaging mechanism could be utilized, including, but not limited to, a hinged engagement or a threaded engagement.

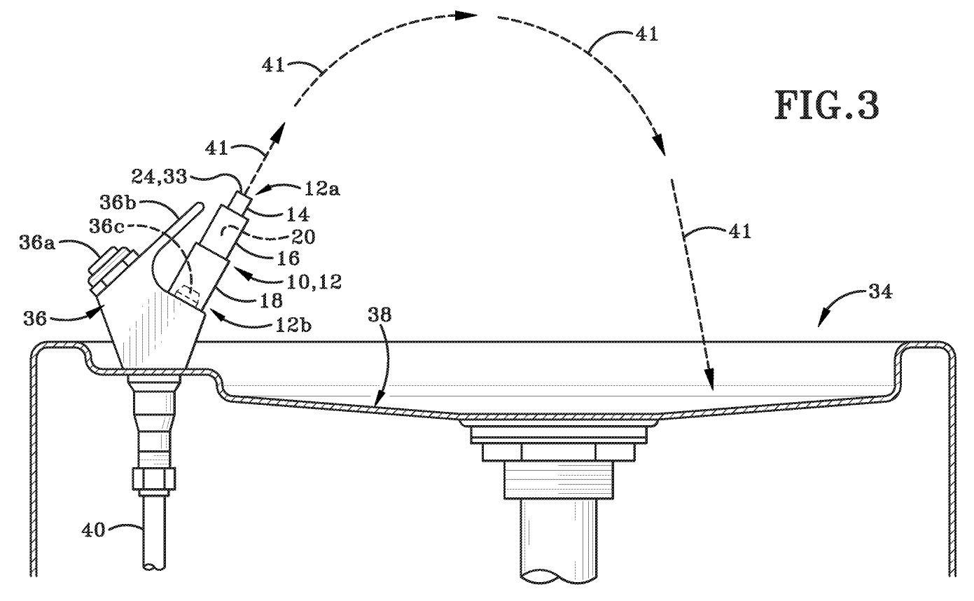

In operation, and with reference to FIG. 3, the water fountain apparatus 10 may be utilized with a water fountain 34 as more fully described herein. Water fountain 34 includes a bubbler head 36, a basin 38, and a water supply 40. The bubbler head 36 includes a valve 36a, a guard member 36b, and a discharge port 36c. In accordance with an aspect of the present disclosure, the water fountain apparatus 10 is configured to be releasably engaged with the discharge port 36c of the bubbler head 36. More particularly, the discharge port 36c of the bubbler head 36 passes through the opening 35 of the bore 20 and is releasably engaged with at least a portion of the inner generally cylindrical surface 18b of the third section 18 through an interference fit engagement. It is envisioned that the water fountain apparatus 10 may be releasably engaged with the discharge port 36c in any suitable manner, including, but not limited to, a magnetic engagement, an adhesive engagement, a threaded/screw-on engagement, a snap-on engagement or than other suitable engaging mechanism.

Once the water fountain apparatus 10 is releasably engaged with the discharge port 36c, the bore 20 defines a flow path for conveying water from the water supply 40 through the bore 20 and out of the opening 33 of the bore 20. When the valve 36a is opened and the cap 22 is removed from the first section 14, the water is conveyed as a controlled stream of water 41 through the bore 20 in an upwardly arcuate manner as shown in FIG. 3. In one embodiment, the water fountain apparatus 10 is single use and disposable. In another embodiment, the water fountain apparatus 10 is a multi-use device that can be sterilized in any suitable manner, such as, for example, washing the water fountain apparatus 10 in a dish washer.

It should be noted that the arc of the controlled stream of water 41 may be different when the water fountain apparatus 10 is releasably engaged with the discharge port 36c compared to when the water fountain apparatus 10 is not releasably engaged with the discharge port 36c. The change in the arc may be based, at least in part, on the controlled stream of water 41 having a higher velocity due to a decrease in pressure in the first section 14 as the diameter of the first bore section 28, which is the same as the second diameter D2, is less than the diameter of the discharge port 36c. Therefore, it may be necessary to adjust the water pressure of the water fountain 34 in order to ensure that the controlled stream of water 41 lands within the basin 38. Further, it is envisioned that the water may be conveyed from the water supply 40 under any suitable pressure. The user then drinks from the controlled stream of water 41. In one example, and instead of drinking from the controlled stream of water 41, the user may place the user's mouth around the opening 33 of the bore 20 to receive the water exiting the opening 33 directly into the user's mouth. The water fountain apparatus 10 prevents a user from coming into contact with the discharge port 36c which may reduce the likelihood of being exposed to undesirable contaminants and/or pathogens and/or the like.

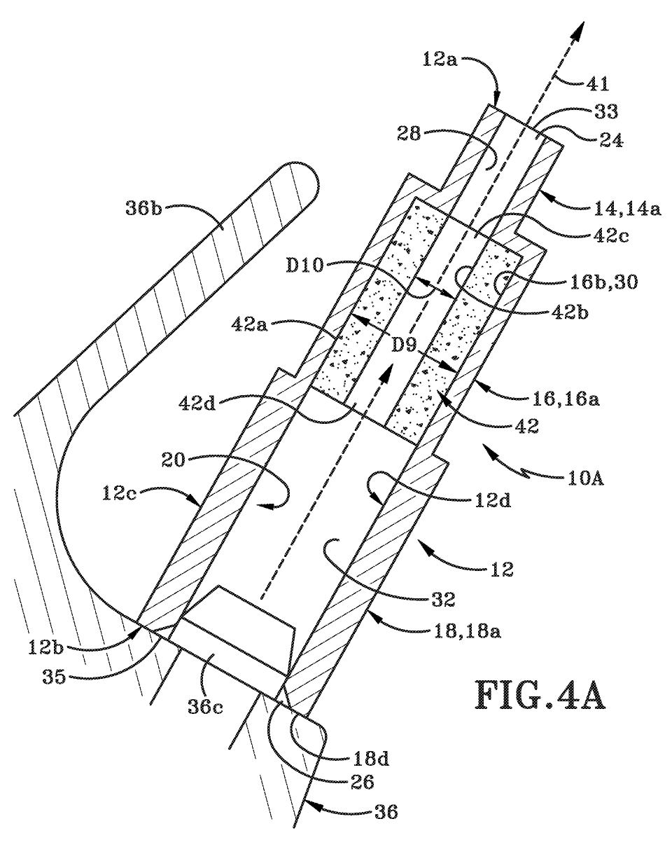

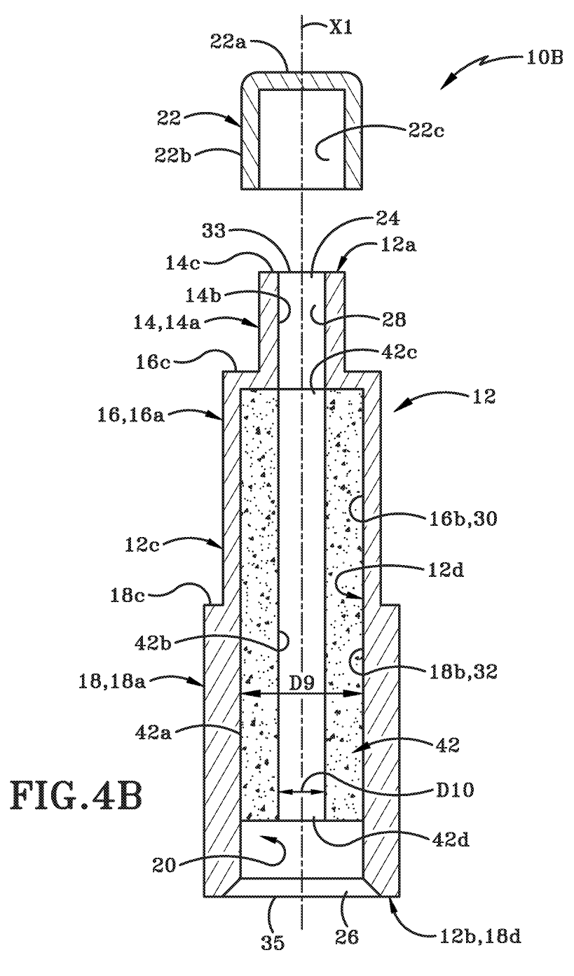

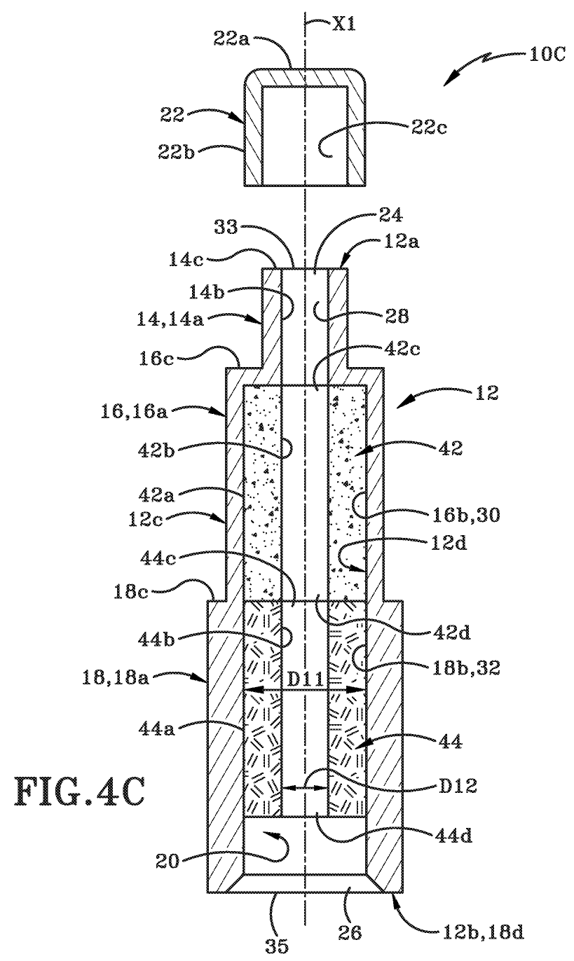

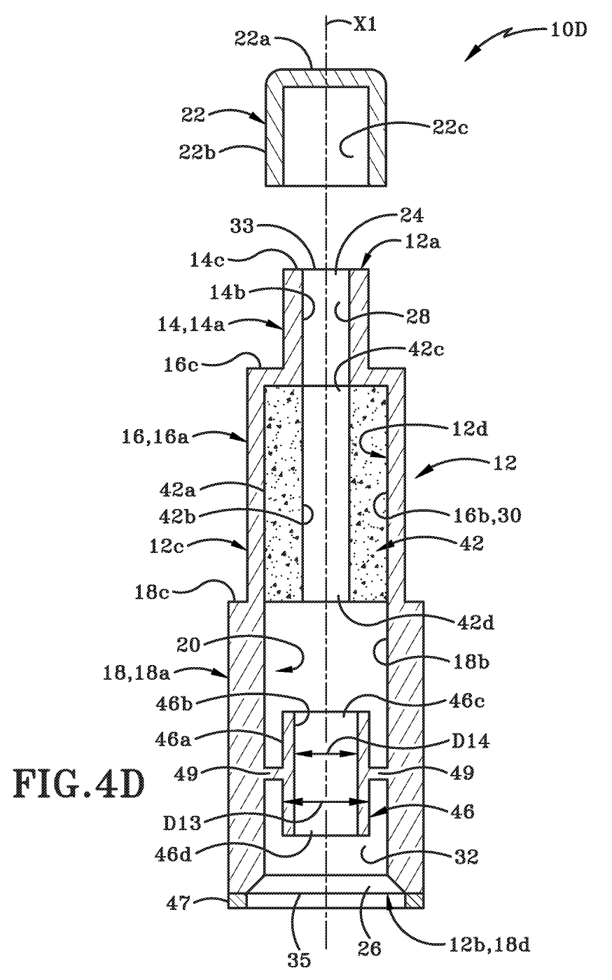

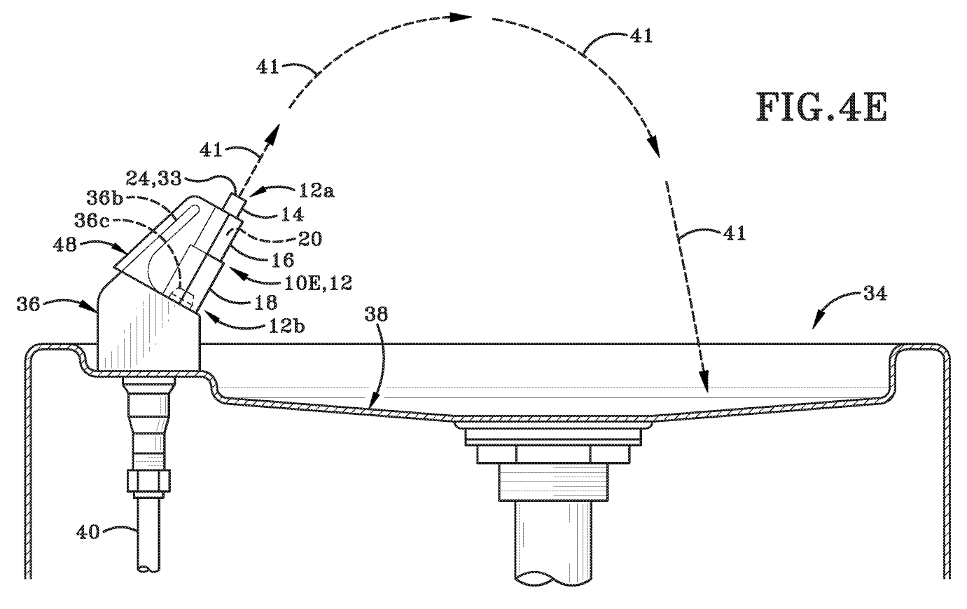

FIG. 4A is a cross-section view of a second embodiment of a water fountain apparatus 10A releasably engaged with the discharge port 36c of the bubbler head 36 of the water fountain 34. Water fountain apparatus 10A is substantially identical to water fountain apparatus 10 in structure and function with a few exceptions/additions that will be discussed hereafter in greater detail.

Water fountain apparatus 10A further includes at least one filter mechanism 42 configured to filter and/or purify the water coming from the water supply 40 and entering the bore 20 to be conveyed to the user's mouth. The filter mechanism 42 may be any suitable type of filter mechanism for removing bacteria, pollutants, contaminants, or the like. The types of filter mechanisms may include, but are not limited to, media filters, screen filters, disk filters, sand filters, cloth filters, biological filters, activated charcoal filters, activated carbon filters, bactericides, and the like. In this embodiment, the water fountain apparatus 10A includes a single filter mechanism 42. The filter mechanism 42 includes an outer generally cylindrical wall 42a having a ninth diameter D9 and an inner generally cylindrical wall 42b having a tenth diameter D10.

As shown in FIG. 4A, the filter mechanism 42 is provided within the second bore section 30 and is held in place via an interference fit engagement. More particularly, the filter mechanism 42 is inserted into bore 20 and pushed upwardly until the filter mechanism 42 contacts the inner generally cylindrical surface 16b within the second bore section 30. Alternatively, the first section 14 and the second section may be engaged via a screwed connection and the first section 14 may be unscrewed from the second section 16 to insert the filter mechanism within the second bore section 30. The filter mechanism 42 includes a first opening 42c and a second opening 42d. A diameter of the first opening 42c and a diameter of the second opening 42d are the same size as the second diameter D2; however the diameter of the first opening 42c and the diameter of the second opening 42d may be any suitable diameters having any suitable lengths. Although the filter mechanism 42 has been described as being engaged with the second bore section 30 via an interference fit engagement, it is envisioned that the filter mechanism 42 may be provided within the second bore section 30 in any suitable manner, such as, for example, adhesively attaching the filter mechanism 42 within the second bore section 30. Further, although the filter mechanism 42 has been described as being cylindrical in shape and circular in cross-section, it is envisioned that the filter mechanism 42 may be any suitable shape and have any suitable cross-section, including, but not limited to being a substantially uniform filter mechanism with no openings. Still further, and although the filter mechanism 42 has been described as being provided within the second bore section 30 of the water fountain apparatus 10A, it is to be entirely understood that the filter mechanism 42 may be provided in any suitable position within the water fountain apparatus 10, including, but not limited to, being provided within the first bore section 28, the third bore section 32, or across the longitudinal axis X1 in any other position within the water fountain apparatus 10A.

In operation, the water fountain apparatus 10A operates in a substantially identical manner to water fountain apparatus 10, except that the filter mechanism 42 filters/purifies the water coming from the water supply 40 through the forced movement of the controlled stream of water 41 through the bore 20 and the filter mechanism 42. After the water is filtered/purified, the controlled stream of water 41 exits the bore 20 in a substantially identical manner that is described in relation to the water fountain apparatus 10.

FIG. 4B is a cross-section view of a third embodiment of a water fountain apparatus 10B. Water fountain apparatus 10B is substantially identical to water fountain apparatus 10A in structure and function with a few exceptions/additions that will be discussed hereafter in greater detail.

Instead of the filter mechanism 42 of the water fountain apparatus 10B being positioned within the second bore section 30, the filter mechanism 42 of the water fountain apparatus 10B is positioned within the second bore section 30 and the third bore section 32. In operation, the water fountain apparatus 10B operates in a substantially identical manner to water fountain apparatus 10A, except that the filter mechanism 42 is larger and covers more area as shown in FIG. 4B.

FIG. 4C is a cross-section view of a fourth embodiment of a water fountain apparatus 10C. Water fountain apparatus 10C is substantially identical to water fountain apparatus 10A and water fountain apparatus 10B in structure and function with a few exceptions/additions that will be discussed hereafter in greater detail.

Water fountain apparatus 10C further includes a second filter mechanism 44 configured to filter and/or purify the water coming from the water supply 40 and entering the bore 20 to be conveyed to the user's mouth. The second filter mechanism 44 may be any suitable type of filter mechanism for removing bacteria, pollutants, contaminants and the like. The types of filter mechanisms may include, but are not limited to, media filters, screen filters, disk filters, sand filters, cloth filters, biological filters, activated charcoal filters, activated carbon filters, bactericides, and the like. In this embodiment, the water fountain apparatus 10C includes a first filter mechanism 42, which is the same filter mechanism as the filter mechanism 42 of the fountain apparatus 10A, and a second filter mechanism 44.

The second filter mechanism 44 includes an outer generally cylindrical wall 44a having an eleventh diameter D11 and an inner generally cylindrical wall 44b having a twelfth diameter D12. The first filter mechanism 42 is provided within the second bore section 30 and is held in place via an interference fit engagement. The second filter mechanism 44 is provided within the third bore section 32 and is held in place via an interference fit engagement.

The second filter mechanism 44 includes a first opening 44c and a second opening 44d. A diameter of the first opening 44c and a diameter of the second opening 44d are the same size as the second diameter D2; however the diameter of the first opening 44c and the diameter of the second opening 44d may be any suitable diameters having any suitable lengths. Although the first filter mechanism 42 has been described as being engaged with the second bore section 30 via an interference fit engagement and the second filter purification mechanism 44 has been described as being engaged with the second bore section 30 via an interference fit engagement, it is envisioned that the first filter mechanism 42 may be provided within the second bore section 30 and the second filter mechanism 44 may be provided within the third bore section 32 in any suitable manner. Further, although the first filter mechanism 42 and the second filter mechanism 44 have been described as being cylindrical in shape and circular in cross-section, it is envisioned that the first filter mechanism 42 and the second filter mechanism 44 may be any suitable shape and have any suitable cross-section, including, but not limited to being a substantially uniform filter mechanism with no openings. Still further, and although the first filter mechanism 42 has been described as being provided within the second bore section 30 and the second filter mechanism 44 has been described as being provided within the third bore section 32, it is to be entirely understood that the first filter mechanism 42 and the second filter mechanism 44 may be provided in any suitable position within the water fountain apparatus 10C, including, but not limited to, being provided within the first bore section 28 or across the longitudinal axis X1 in any other position within the water fountain apparatus 10C.

In operation, the water fountain apparatus 10C operates in a substantially identical manner to water fountain apparatus 10B, except that the water fountain apparatus 10C includes the first filter mechanism 42 and the second filter mechanism 44 as shown in FIG. 4C.

FIG. 4D is a cross-section view of a fifth embodiment of a water fountain apparatus 10D. Water fountain apparatus 10D is substantially identical to water fountain apparatus 10A in structure and function with a few exceptions/additions that will be discussed hereafter in greater detail.

Water fountain apparatus 10D further includes an insert 46 configured to be positioned within a periphery of the discharge port 36c so that the water coming from the water supply 40 enters the insert 46 before entering the bore 20 to be conveyed to the user's mouth. The water fountain apparatus 10D further includes an engaging mechanism 47 that operably engages the water fountain apparatus 10D to the water fountain 34.

The insert 46 includes an outer generally cylindrical wall 46a having a thirteenth diameter D13 and an inner generally cylindrical wall 46b having a fourteenth diameter D14. The insert 46 is provided within the third bore section 32 of the bore 20 and may be operably engaged with the third bore section 32 in any suitable manner, such as, for example, engagement points 49. The insert 46 includes a first end 46c and a second end 46d, and a through hole 46e. A diameter of the first end 46c and the second end 46d are configured to fit within the periphery of the discharge port 36c; however the diameters of the first end 46c and the second end 46d may be any suitable diameters having any suitable lengths. Although the insert 46 has been described as being connected to the third bore section 32 via the engagement points 49, the insert 46 may be provided within the third bore section 32 in any suitable manner. Although the insert 46 has been described as being cylindrical in shape and circular in cross-section, it is envisioned that the insert 46 may be any suitable shape and have any suitable cross-section.

As shown in FIG. 4D, the engaging mechanism 47 is an annular magnet attached to the bottom wall 18d of the water fountain apparatus 10D. The engaging mechanism 47 may be operably engaged with the water fountain apparatus 10D in any suitable manner, such as, for example, being operably engaged via an adhesive. Although the engaging mechanism 47 has been described as being a magnet, the engaging mechanism 47 may be any suitable engaging mechanism, including, but not limited to, an adhesive or a conformable material configured to conform to the discharge port 36c of the bubbler head 36 or any other suitable component of the water fountain 34.

In operation, the water fountain apparatus 10D operates in a substantially identical manner to water fountain apparatus 10A, except that the water fountain apparatus is releasably engaged with the discharge port 36c via the engaging mechanism 47 (i.e. the magnet) and that the water coming from the water supply 40 travels through the insert 46 before entering the third bore section 32. After the water is filtered/purified by the filter mechanism 42, the water enters the user's mouth.

FIG. 4E is an environmental view of a sixth embodiment of a water fountain apparatus 10E. Water fountain apparatus 10E is substantially identical to water fountain apparatus 10A in structure and function with a few exceptions/additions that will be discussed hereafter in greater detail.

Water fountain apparatus 10E further includes at least one cover 48 configured to cover a portion of the bubbler head 36. More particularly, the cover 48 is configured to cover the guard member 36b of the bubbler head 36. Although the cover 48 has been described as covering the guard member 36b, it is to be entirely understood that the cover 48 may cover any suitable part of portion of the water fountain 34. Further, it is to be entirely understood that the cover 48 may be any suitable size and shape.

In operation, the water fountain apparatus 10E operates in a substantially identical manner to water fountain apparatus 10A, except that the cover 48 covers the guard member 36b of the bubbler head 36.

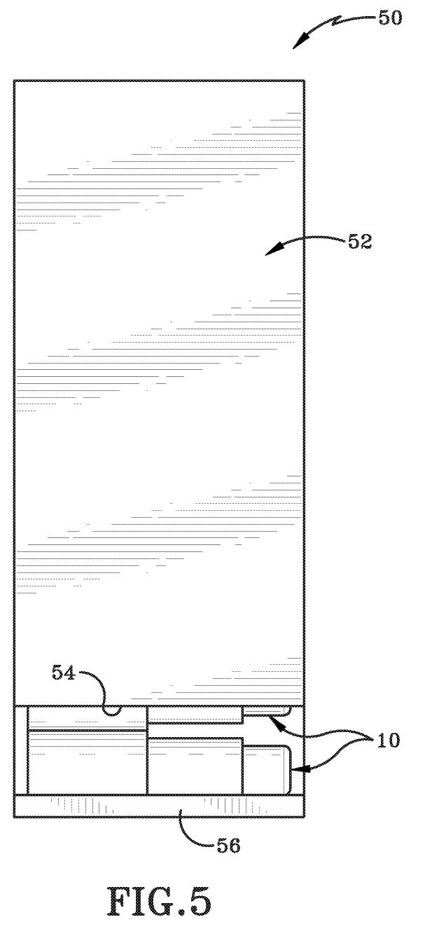

In accordance with one aspect of the present disclosure, the water fountain apparatuses 10, 10A, 10B, 10C, 10D, and 10E, may be stored and dispensed from a storage/dispensing container. One embodiment of a storage dispensing container is shown in FIG. 5, and is denoted generally at 50. Although all water fountain apparatuses 10, 10A, 10B, 10C, 10D, and 10E may be stored and dispensed form the storage/dispensing container 50, FIG. 5 shows the storage/dispensing container 50 being utilized with the water fountain apparatus 10. In one particular embodiment, the storage/dispensing container 50 may include a storage container 52, an aperture 54, and a tray 56. The aperture 54 is sized so that the water fountain apparatus 10 is retrievable by the hand of a user.

In operation, the water fountain apparatuses 10 are placed within the storage container 52 for storage. A user then retrieves the bottommost water fountain apparatus 10 from a stack of water fountain apparatuses 10 supported by the tray 56. After the user retrieves the water fountain apparatus 10, the user may operably engage the water fountain apparatus over the discharge port 36c of the bubbler head 36 as described above.

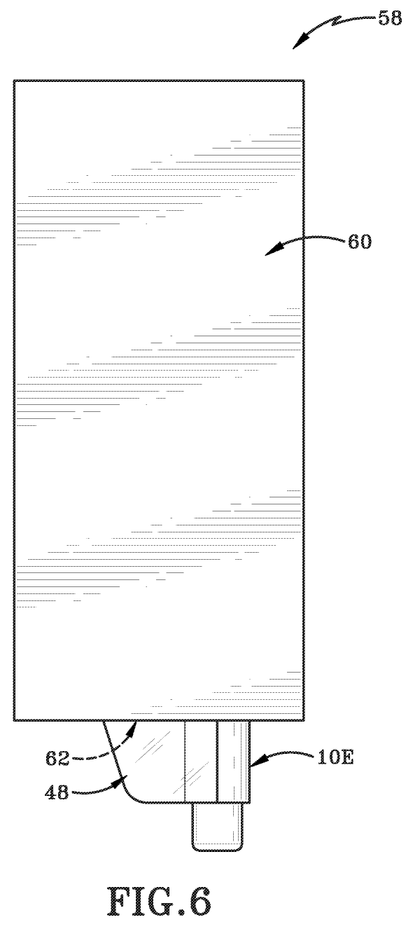

In accordance with one aspect of the present disclosure, the water fountain apparatuses 10, 10A, 10B, 10C, 10D, and 10E, may be stored and dispensed from another embodiment of a storage/dispensing container, which is shown in FIG. 6 and is generally denoted as 58. Although all water fountain apparatuses 10, 10A, 10B, 10C, 10D, and 10E may be stored and dispensed form the storage/dispensing container 58, FIG. 6 shows the storage/dispensing container 58 being utilized with the water fountain apparatus 10E. In one particular embodiment, the storage/dispensing container 58 may include a storage container 60 and an aperture 62. The aperture 62 may be sized so that the water fountain apparatus 10E may be releasably held by an interference fit engagement with a perimeter of the aperture 62 to be retrieved by the hand of a user.

In operation, the water fountain apparatuses 10E are placed within the storage container 58 for storage. A user then retrieves the bottommost water fountain apparatus 10E from a stack of water fountain apparatuses 10 supported by the perimeter of the aperture 62. After the user retrieves the water fountain apparatus 10E, the user may operably engaged the water fountain apparatus such that the cover 48 covers the guard member 36b and the water fountain apparatus 10E is operably engaged with the discharge port 36c of the bubbler head 36 as described above.

Collectively, the plurality of water fountain apparatuses 10, 10A, 10B, 10C, 10D, and 10E, the storage/dispensing containers 50 and 58, and the water fountain 34 may define a sanitary system as more fully described herein. Although other combinations are entirely possible, an exemplary sanitary system may utilize the water fountain apparatus 10, the storage/dispensing container 50 and the water fountain 34. In this example, the storage/dispensing container 50 may be mounted near the water fountain 34 in any suitable manner, such as, for example, by an adhesive. The storage/dispensing container 50 may store a plurality of water fountain apparatuses 10. When a user desires to drink from the water fountain 34, the user retrieves a water fountain apparatus 10 from the storage/dispensing container 50 and operably engages the water fountain apparatus 10 with the water fountain 34 as described above to prevent contamination to the user. It is envisioned that the sanitary system may be utilized wherever water fountains 34 are available, for example, but not limited to, near schools, hospitals, parks or the like.

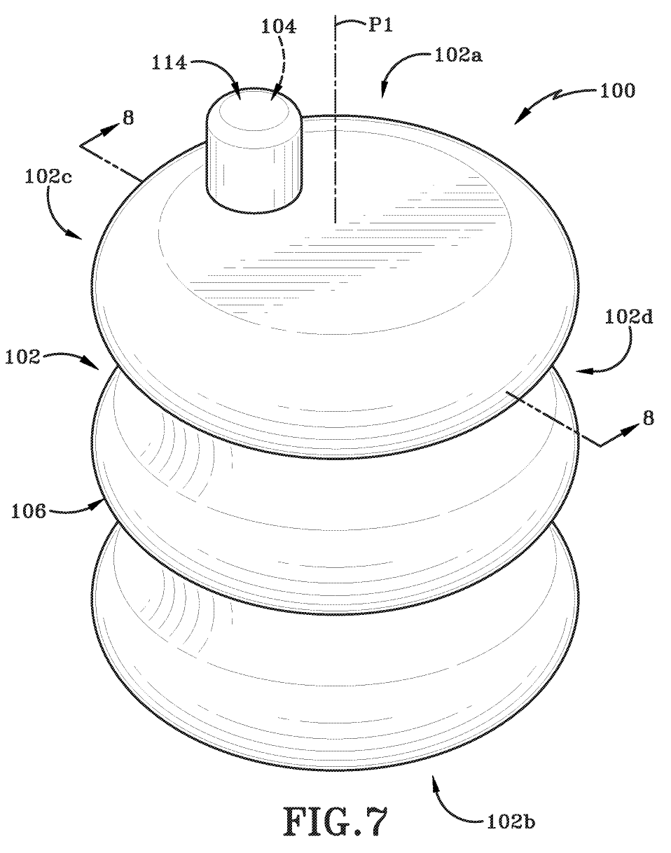

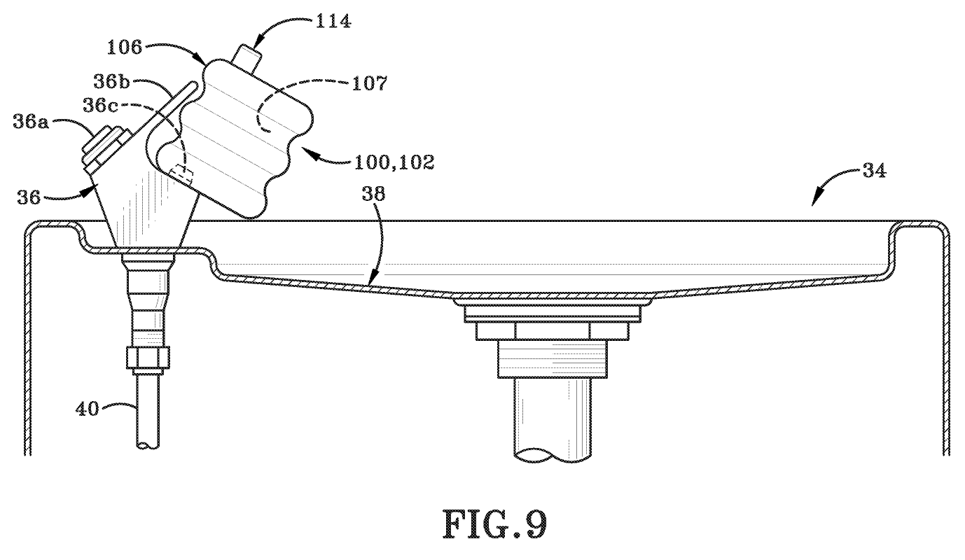

Referring to FIG. 7-FIG. 9, there is shown a seventh embodiment of a water fountain apparatus in accordance with one aspect of the present disclosure, with the water fountain apparatus generally indicated at 100.

With reference to FIG. 7, the water fountain apparatus 100 includes a generally elongated body 102. The body 102 includes a top end 102a, a bottom end 102b, a first side 102c, and second side 102d. The top end 102a and the bottom end 102b define a longitudinal direction therebetween. The first side 102c and the second side 102d define a transverse direction therebetween. The body 102 further includes a central vertical longitudinal plane P1 extending generally longitudinally from the top end 102a through the bottom end 102b approximately midway between the first side 102c and the second side 102d.

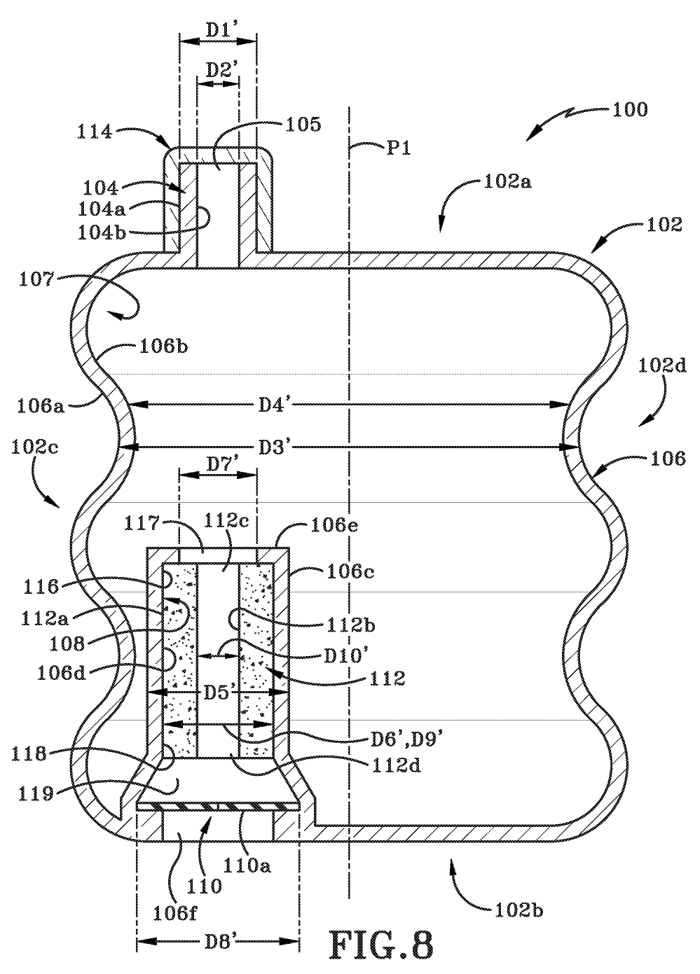

As shown in FIG. 7 and FIG. 8, the body 102 includes a first section 104 and a second section 106 disposed longitudinally below the first section 104. The first section 104 includes an outer generally cylindrical wall 104a having a first diameter D1′ and an inner generally cylindrical surface 104b having a second diameter D2′. The inner generally cylindrical surface 104b defines a bore 105 (FIG. 8) that has an opening (not numbered). The first diameter D1′ and the second diameter D2′ may be sized so that a user's mouth may fit over at least a portion of the first section 104.

With continued reference to FIG. 8, the second section 106 includes a generally cylindrical wall having an outer surface 106a and an inner surface 106b. The outer surface 106a is of a varying third diameter D3′ and the inner surface 106b is of a varying fourth diameter D4′. Second section 106 further includes an interior tubular member having an outer surface 106c of a fifth diameter D5′ and an inner surface 106d having a sixth diameter D6′. Fourth diameter D4′ is greater than the second diameter D2′ and the sixth diameter D6′. The interior tubular member has a top surface 106e, and a bottom aperture 106f defined by the outer surface 106a. As shown in FIG. 8, the inner surface 106b of second section 106, the outer surface 106c and top surface 106e of the interior tubular member bound and define an interior cavity 107. The interior cavity 107 is interposed between the bore 105 and the bore 108. The interior cavity 107 is configured to releasably receive water as further described below.

With continued reference to FIG. 8, the body 102 further includes a bore 108. The bore 108 includes a first end 116 and a second end 118. The bore 108 is defined by the inner surface 106d. As such, a diameter of the bore 108 is the same as the sixth diameter D6′. (It should be noted that the sixth diameter D6′ is greater than the second diameter D2′ of bore 105.) The body 102 includes an opening 117 defined by the top generally annular surface 106e of the second section 106. The opening 117 has a seventh diameter D7′. The bore 108 is fluid communication with the opening 117. The body 102 includes an opening 119 defined by the inner surface 106d of the second section 106. The bore 108 is fluid communication with the opening 119. As shown in FIG. 8, the bore 108 further includes a valve mechanism 110. The valve mechanism 110 has an eighth diameter D8′ that tapers longitudinally toward the top end 102a of the body 102. The valve mechanism 110 includes a valve membrane 110a and the valve membrane 110a is in fluid communication with the bottom aperture 106f. As shown in FIG. 8, the opening 119 is in fluid communication with the valve mechanism 110. The bore 108 is formed radially outward from the central longitudinal plane P1 which allows the water fountain apparatus to be connected to the discharge port 36c. Although the bore 108 has been described as being formed radially outward from the central longitudinal plane P1, the bore 108 may be formed in any suitable manner.

The water fountain apparatus 100 further includes a filter mechanism 112. The filter mechanism 112 may be any suitable type of filter mechanism for removing bacteria, pollutants, contaminants and the like. The types of filter mechanisms may include, but are not limited to, media filters, screen filters, disk filters, sand filters, cloth filters, biological filters, activated charcoal filters, activated carbon filters, bactericides, and the like.

The filter mechanism 112 includes an outer generally cylindrical wall 112a having a ninth diameter D9′ and an inner generally cylindrical wall 112b having a tenth diameter D10′. The filter mechanism 112 is provided within the bore 108 and is held in place via an interference fit engagement. The filter mechanism 112 includes a first opening 112c and a second opening 112d. A diameter of the first opening 112c and a diameter of the second opening 112d are the same size as the second diameter D2′; however the diameter of the first opening 112c and the diameter of the second opening 112d may be any suitable diameters having any suitable lengths. Although the filter mechanism 112 has been described as being engaged within the bore 108 via an interference fit engagement, it is envisioned that the filter mechanism 112 may be provided within the bore 108 in any suitable manner. Further, although the filter mechanism 112 has been described as being cylindrical in shape and circular in cross-section, it is envisioned that the filter mechanism 112 may be any suitable shape and have any suitable cross-section, including, but not limited to being a substantially uniform filter mechanism with no openings. Still further, and although the filter mechanism 112 has been described as being provided within the bore 108 of the water fountain apparatus 100, it is to be entirely understood that the filter mechanism 112 may be provided in any suitable position within the water fountain apparatus 100, including, but not limited to, being provided within the first section 104.

As shown in FIG. 7 and FIG. 8, the first section 104 and the second section 106 are integrally molded as a single monolithic component. Although the first section 104 and the second section 106 have been described as being integrally molded as a single monolithic component, it is to be entirely understood that that the first section 104 and the second section 106 may be formed in any suitable manner.

As shown in FIG. 7, the body 102 further includes a cap 114 that is releasably engageable with at least a portion of the first section 104 and is configured to cover an opening to bore 105 as further described below. With continued reference to FIG. 7, the cap 114 is a cap configured to be releasably engaged with at least a portion of the first section 104 via an interference fit engagement to cover the bore 105. Although the engagement of the cap 114 to the first section 104 has been described as being an interference fit engagement, it is envisioned that any suitable engaging mechanism could be utilized, including, but not limited to, a hinged engagement or a threaded engagement.

In operation, and with reference to FIG. 7 through FIG. 9, the water fountain apparatus 100 may be utilized with the water fountain 34 having a bubbler head 36, a basin 38, and a water supply 40. The bubbler head 36 includes a valve 36a, a guard member 36b, and a discharge port 36c. The water fountain apparatus 100 is releasably engaged with the discharge port 36c of the bubbler head 36. More particularly, the discharge port 36c of the bubbler head 36 passes through the valve mechanism 110 and is releasably engaged therewith through an interference fit engagement. The discharge port 36c is in fluid communication with the bore 108 which defines a flow path for conveying water from the water supply 40 when the valve 36a is open through the bore 108 and filter mechanism 112 to the interior cavity 107 of the body 102. The user fills the interior cavity 107 with water until it reaches a volume as selected by the user. The user removes the cap 114 and conveys water through the bore 105 to the user's mouth. In one example, the water fountain apparatus 100 prevents a user from coming into contact with the discharge port 36c which may reduce the likelihood of the user being exposed to undesirable contaminants or the like.

It is further envisioned that the water fountain apparatus 100 may incorporate various components of the water fountain apparatuses 10, 10A, 10B, 10C, 10D and 10E including, but not limited to, the insert 46 and the engaging mechanism 47.

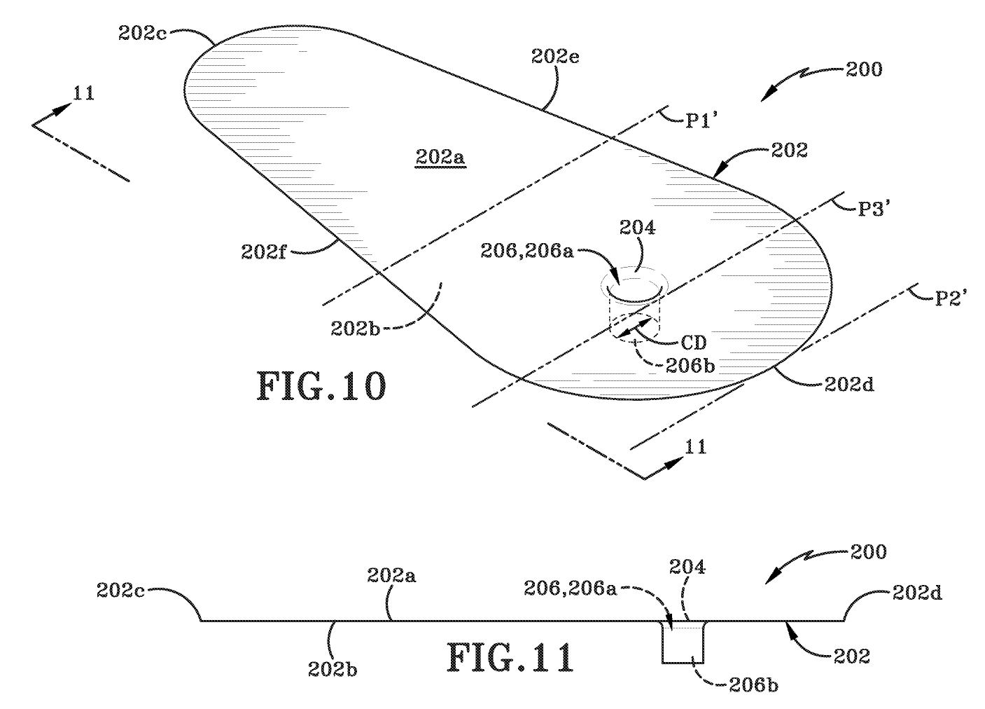

Referring to FIG. 10-FIG. 13, there is shown an eighth embodiment of a water fountain apparatus in accordance with one aspect of the present disclosure, with the water fountain apparatus generally indicated at 200. The water fountain apparatus includes a body 202. In one example, body 202 may comprise a generally elongated planar member and may be made of a bendable material. The body 202 includes a top surface 202a, a bottom surface 202b, a first end edge 202c, a second end edge 202d, a first side edge 202e, and a second side edge 202f. The top surface 202a and the bottom surface 202b define a vertical direction therebetween. The first end edge 202c and the second end edge 202d define a longitudinal direction therebetween. The first side edge 202e and the second side edge 202f define a transverse direction therebetween.

As shown in FIG. 10, the first end edge 202c, and the second end edge 202d are both generally arcuate edges with the second end edge 202d being larger than the first end edge 202c. The first side edge 202e and the second side edge 202f extend generally longitudinally between the first end edge 202c and the second end edge 202d at an angle due to the different sizes between the first end edge 202c and the second end edge 202d. The top surface 202a and the bottom surface 202b are bounded by the first end edge 202c, the second end edge 202d, the first side edge 202e, and the second side edge 202f. In one example, the top surface 202a and the bottom surface 202b form an elongated tear drop shape; however, the top surface 202a and the bottom surface 202b may form any suitable shape.

An aperture 204 is defined in body 202. Aperture 204 extends between top surface 202a and bottom surface 202b. The aperture 204 is oriented generally vertically between top surface 202a and bottom surface 202b.

With continued reference to FIG. 10, the water fountain apparatus 200 further includes a conduit 206. The conduit 206 is a generally elongated tubular member having passageway with a top opening 206a and a bottom opening 206b. The conduit 206 extends outwardly from at least one of the top surface 202a and the bottom surface 202b of the body 202. In one example, shown in FIGS. 10 and 11, conduit 206 extends downwardly from bottom surface 202b and top opening 206a is in fluid communication with the aperture 204 of the body 202. In one example, the passageway may be perpendicular to the aperture. (In other instances, conduit 206 may extends upwardly from top surface 202a and bottom opening 206b may be in fluid communication with aperture 204. In yet other instances, conduit 206 may extend partially upwardly from top surface 202a and downwardly from bottom surface 202b.) The conduit 206 may be operably engaged with the body 202 in any suitable manner, such as, for example, by being molded integrally therewith or by being secured thereto with an adhesive. The conduit 206 includes a passageway diameter CD that is sized to be releasably engaged with a discharge port 36c of a bubbler head 36 as further described below.

With continued reference to FIG. 10, the water fountain apparatus 200 further includes a central transverse plane P1′ extending between the first side edge 202e and the second side edge 202f, an outer transverse plane P2′ defined by an outermost point of the second end edge 202d, and a third transverse plane P3′ defined by a longitudinal most point of the top opening 206a of the conduit 206 toward the second end edge 202d. As shown in FIG. 10, the conduit 206 is positioned between the first plane P1′ and the third plane P3′. Although a particular position of the conduit 206 has been described, it is to be entirely understood that the bore may be provided in any suitable position. For example, and not meant as a limitation, the conduit 206 may be provided proximate the second plane P2′.

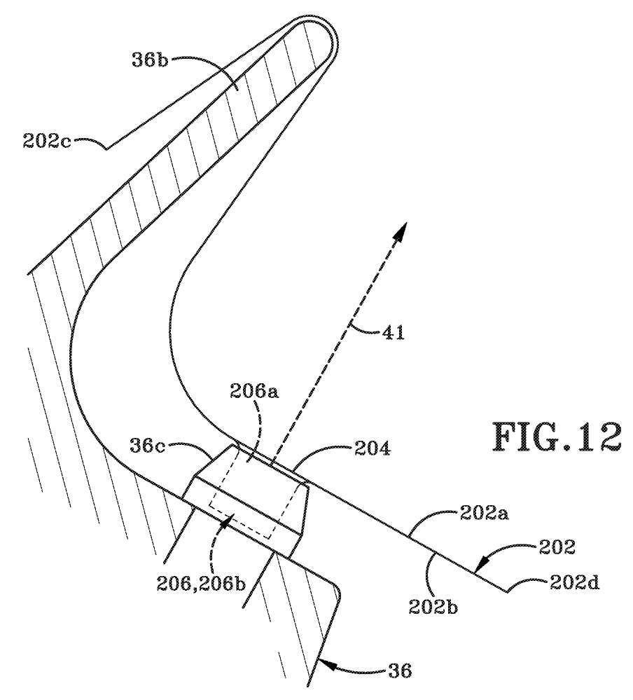

In operation, and with reference to FIG. 12, the water fountain apparatus 200 may be utilized with a water fountain 34 as more fully described herein. Water fountain 34 includes a bubbler head 36, a basin 38, and a water supply 40. The bubbler head 36 includes a valve 36a, a guard member 36b, and a discharge port 36c. The water fountain apparatus 200 is releasably engaged with the discharge port 36c of the bubbler head 36. More particularly, the conduit 206 positioned within a periphery of the discharge port 36c via an interference fit engagement so that the water coming from the water supply 40 enters the conduit 206 through the bottom opening 206b and exits the top opening 206a and the aperture 204 to be conveyed to the user's mouth. The body 202 may serve as a cover to protect the user from contamination. For example, and as shown in FIG. 12, the body may cover at least the guard member 36b of the bubbler head as well as other portions of the water fountain. Although the water fountain apparatus 200 has been described as being releasably engaged with the discharge port 36c through an interference fit engagement between the conduit 206 and the discharge port 36c of the bubbler head 36, the water fountain apparatus 200 may be releasably engaged with the discharge port 36c in any suitable manner, including, but not limited to, a magnetic engagement, an adhesive engagement, a threaded/screw-on engagement, a snap-on engagement or than other suitable engaging mechanism.

Once the water fountain apparatus 200 is releasably engaged with the discharge port 36c, the conduit 206 defines a flow path for conveying water from the water supply 40 through the conduit 206 and out of the aperture 204. When the valve 36a is opened, the water is conveyed as a controlled stream of water 41 through the conduit 206 in an upwardly arcuate manner as shown in FIG. 12.

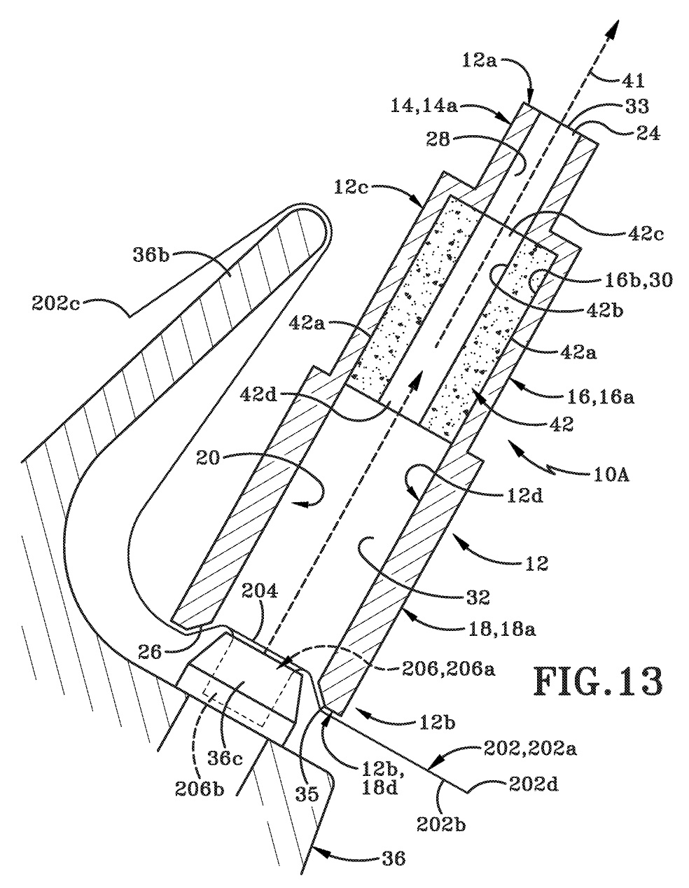

It is envisioned that the water fountain apparatus 200 may be operably engaged with one of the water fountain apparatuses 10, 10A, 10B, 10C, 10D, and 10E to provide further protection. For example, and not meant as a limitation, and with reference to FIG. 13, the water fountain apparatus 200 may be operably engaged with the water fountain apparatus 10A with an adhesive. The combination of the water fountain apparatus 200 and the water apparatus 10A may be utilized in a similar manner as described above.

Although a particular water fountain 34 has been described, it is to be entirely understood that the teachings of the present disclosure may be utilized with any suitable type of water fountain, including, but not limited to, a water fountain having a discharge port configured to convey water vertically downward.

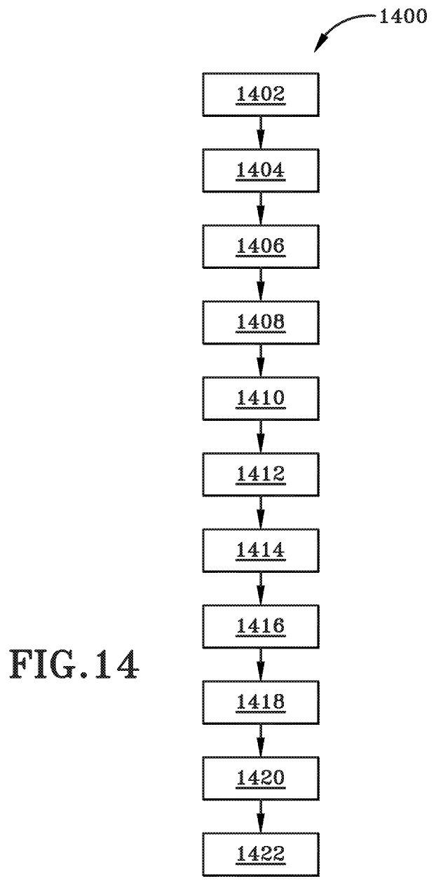

FIG. 14 depicts an exemplary method or process in accordance with one aspect of the present disclosure and is generally referred to as 1400. The method 1400 includes providing a body including a wall having a top end, a bottom end and an interior surface that bounds and defines a bore; wherein the bore extends from an opening in the top end to an opening in the bottom end, which is generally shown at 1402. The method 1400 includes positioning the bottom end of the body over a discharge port of a water fountain, which is generally shown at 1404. The method 1400 includes establishing fluid communication between the bore and the discharge port, which is shown generally at 1406. The method includes conveying water from the discharge port through the bore and out of the opening in the top end, which is shown generally at 1408. The method 1400 includes preventing germs on the water fountain from contacting a user, which is shown generally at 1410. The method 1400 includes filtering the water via the filtering mechanism provided in the bore, which is shown generally at 1412. The method 1400 includes operably engaging the bottom end of the body with the discharge port via a connection mechanism, which is shown generally at 1414. The method 1400 includes magnetically engaging the bottom end of the body with the discharge port, which is shown generally at 1416. In one example, conveying water from the discharge port through the bore may be accomplished by depressing a button on the water fountain. In another example, conveying water from the discharge port through the bore is accomplished by activating a motion sensor (not shown). The method 1400 includes providing a storage/dispensing container proximate the water fountain, which is shown generally at 1418. The method 1400 includes storing the body within the storage/dispensing container, which is shown generally at 1420. The method 1400 includes retrieving the body from the storage/dispensing container prior to positioning the bottom end of the body over the discharge port of the water fountain, which is shown generally at 1422.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in engagement with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A water fountain apparatus comprising:
a body including a wall, a top end, a bottom end, wherein the wall has an interior surface; and
a bore defined by the interior surface; wherein the bore extends from an opening in the top end to an opening in the bottom end; wherein the bore includes a first portion proximate the top end and a second portion proximate the bottom end; and wherein the second portion of the bore is of a greater diameter than the first portion of the bore.

2. The water fountain apparatus of claim 1, further comprising:
a filter mechanism provided within the bore.

3. The water fountain apparatus of claim 2, wherein the filter mechanism is provided within the second portion of the bore.

4. The water fountain apparatus of claim 1, further comprising:
an engaging mechanism operably engaged with the bottom end of the body.

5. The water fountain apparatus of claim 4, wherein the engaging mechanism is a magnet.

6. The water fountain apparatus of claim 1, further comprising:
a cover operably engaged with the body, wherein the cover is adapted to cover a portion of a water fountain.

7. The water fountain apparatus of claim 1, further comprising:
an insert, wherein the insert includes an exterior wall, a first end, a second end, an interior surface, and a through hole; wherein the through hole extends from an opening in the first end of the insert to an opening in the second end of the insert; and wherein the insert is located within the bore.

8. The water fountain apparatus of claim 1, further comprising a valve mechanism that is located in the bore; and wherein the valve mechanism is movable between an open position and a closed position.

9. The water fountain apparatus of claim 8, wherein the interior surface of the wall of the body further defines an interior cavity and part of the interior cavity is interposed between the first portion of the bore and the second portion of the bore;
and wherein the interior cavity is of a greater diameter than the first portion of the bore and the second portion of the bore.

10. A water fountain apparatus comprising:
a body having a top surface and a bottom surface;
an aperture defined by body and extending between the top surface and the bottom surface; and
a conduit having a passageway; said conduit extending outwardly from one of the top surface and the bottom surface of the body, said conduit being positioned such that the passageway is in fluid communication with the aperture.

11. The water fountain apparatus of claim 10, wherein the passageway is substantially perpendicular to the bottom surface of the body.

12. The water fountain apparatus of claim 10, wherein the body is made of a bendable material.

13. A method comprising:
providing a body including a wall having a top end, a bottom end and an interior surface that bounds and defines a bore; wherein the bore extends from an opening in the top end to an opening in the bottom end;
positioning the bottom end of the body over a discharge port of a water fountain;
establishing fluid communication between the bore and the discharge port; and
conveying water from the discharge port through the bore and out of the opening in the top end.

14. The method of claim 13, further comprising:
preventing germs on the water fountain from contacting a user.

15. The method of claim 13, further comprising:
filtering the water via a filter mechanism provided in the bore.

16. The method of claim 13, further comprising:
operably engaging the bottom end of the body with the discharge port via a connection mechanism.

17. The method of claim 16, magnetically engaging the bottom end of the body with the discharge port.

18. The method of claim 13, wherein conveying water from the discharge port through the bore is accomplished by depressing a button on the water fountain.

19. The method of claim 13, wherein conveying water from the discharge port through the bore is accomplished by activating a motion sensor.

20. The method of claim 13, further comprising:
providing a storage/dispensing container proximate the water fountain;
storing the body within the storage/dispensing container; and
retrieving the body from the storage/dispensing container prior to positioning the bottom end of the body over the discharge port of the water fountain.
